(19) United States
(12) Patent Application Publication
(10) Pub. No.: US 2017/0174998 A1
(43) Pub. Date: Jun. 22, 2017

(54) EXTRACTION SYSTEM AND PROCESS FOR REMOVAL OF CONTAMINANTS FROM SOLID MATERIALS

(71) Applicant: Crown Iron Works Company, Roseville, MN (US)

(72) Inventors: Patrick Wayne Harrington, Minneapolis, MN (US); Kevin William Capp, Andover, MN (US)

(21) Appl. No.: 15/382,185

(22) Filed: Dec. 16, 2016

Related U.S. Application Data
(60) Provisional application No. 62/268,713, filed on Dec. 17, 2015.

(51) Int. Cl. C10B 57/00; B01D 11/02

(52) U.S. Cl. CPC C10B 57/005; B01D 11/0292; B01D 11/0223; B01D 2011/002

(57) ABSTRACT

A technique for purifying solid materials containing contaminants, such as petroleum coke, may involve introducing the contaminated solid material into an extractor vessel along with an organic solvent. The contaminated solid material and organic solvent may be conveyed in a countercurrent direction during which the contaminant is extracted at least partially out of the solid material and into the solvent. After extraction, the resulting extracted solid material can be processed in a desolventizing unit and the recovered solvent sent back to the extractor. Further, the solvent containing extracted contaminant can be processed in a solvent recovery unit, further recovering solvent that can be sent back to the extractor.

### RELATED MATTERS

This application claims priority to U.S. Provisional Application No. 62/268,713, filed Dec. 17, 2015, the entire contents of which are incorporated herein by reference.

### TECHNICAL FIELD

This disclosure relates to solvent extraction and, more particularly, to the extraction of contaminants from solid materials using liquid solvent extractors.

### BACKGROUND

Solid materials, such as soil, petroleum coke, and oil sand tailings, may contain contaminants that prevent the materials from being used in desired applications or from being safely and cost effectively disposed. For example, the solid materials may contain sulfur, mercury, heavy metals, or other contaminants that are desirably removed in order to use or safely dispose of the solid material.

### SUMMARY

In general, this disclosure is directed to systems and techniques for removing contaminants from solid materials. While the disclosed systems and techniques can utilize a variety of different solid materials desirably processed, in some examples, the solid material is a petroleum coke produced from an oil refinery coker unit or other cracking processing. Example coking processes that may make petroleum coke include contact coking, fluid coking, flexicoking and delayed coking. Such coke may contain heavy metals or other contaminants that may be desirably removed and recovered from the coke.

In some examples, a technique is described that involves introducing a solid material containing a contaminant into an extractor and extracting at least some of the contaminant contained in the solid material from the solid material using a solvent within the extractor, thereby producing a solvent with increased concentration of contaminant and a solid material with reduced concentration of contaminant. The solid material with reduced concentration of contaminant can be discharged from the extractor and conveyed to a desolventizer. In addition, the solvent having an increased concentration of contaminant can be discharged from the extractor and conveyed to a solvent recovery unit. The solid material with reduced concentration of contaminant can be desolventized using the desolventizer and the solvent with increased concentration of contaminant can be processed in the solvent recovery unit recover contaminants. This can yield multiple product streams, including a stream of solid material having a reduced concentration of contaminant and a stream of material (e.g., one or more metal) recovered from the solvent used to process the solid material.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a functional block diagram illustrating an example solid-solvent extraction system.

FIG. 2 is a block diagram illustrating an example solid-solvent extraction process.

### DETAILED DESCRIPTION

This disclosure relates to extractor systems and extraction processes for removing contaminants from solid material. In some examples, the solid material is a carbonaceous material, such as a residue or byproduct of a crude oil extraction or processing facility. For example, the solid material may be petroleum coke from a petroleum refinery, oil sands tailings, or other carbonaceous material derived from crude oil processing. Example types of petroleum coke include sponge coke, needle coke, and shot coke. In other examples, the solid material is an earthen material, such as soil, which may be or include clay, sand, and/or gravel. The solid material can contain contaminants, which may or may not be carbonaceous. For example, the solid materials may contain sulfur, mercury, heavy metals, or other contaminants. Example heavy metal contaminants include aluminum, antimony, cobalt, copper, iron, manganese, molybdenum, nickel, selenium, silver, tin, vanadium, zinc, and combinations thereof.

In accordance with the present disclosure, extractor systems and extraction processes are used to remove contaminants from solid materials being processed. In one example, a continuous solid-liquid extractor is used to extract the contaminant(s) from the solid materials. In different examples, the extractor may be a screw extractor, immersion extractor, or other type of extractor. The extractor can have a feed inlet that receives the solid material being processed, a feed outlet that discharges the solid material after extraction, a solvent inlet that receives incoming solvent, and a solvent outlet that discharges solvent having an increased concentration of contaminants extracted out of the solid material. The extractor may also have a conveyance system that moves the solid material from the feed inlet to the feed outlet.

In operation, the solid material is contacted with the solvent inside of the extractor, causing the contaminant(s) to leach or transfer from the solid material into the solvent. In some examples, the extractor is a continuous counter-current extractor in which solid material being processed moves from the feed inlet to the feed outlet in on direction while solvent moves from the solvent inlet to the solvent outlet in the opposite direction. The concentration of contaminant may progressively increase in the solvent as it moves from the solvent inlet to the solvent outlet, while the concentration of the contaminant correspondingly decreases as the solid moves in the feed inlet to the feed outlet. The solvent used in the extraction process may be any desired type of solvent. For example, the solvent may be an organic solvent such as hexane, toluene, acetone, alcohol (e.g., isopropyl alcohol, ethanol), or the like.

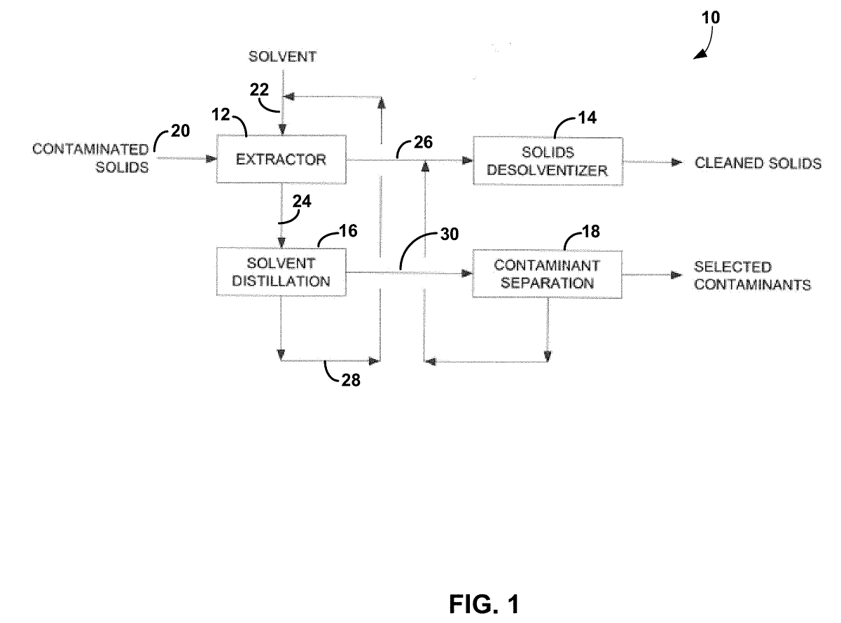

FIG. 1 is a functional block diagram illustrating an example solid-solvent extraction system that can be used according to the disclosure. As shown, the solid-solvent extraction system 10 includes an extractor 12, solids desolventizer 14, solvent recovery or distillation unit 16, and contaminant separation unit 18. Extractor 12 receives contaminated solids 20 and solvent 22 and contacts the contaminated solids with the solvent inside of the extractor. The solvent extracts contaminants from the contaminated solids 20, resulting in a solvent stream with increased concentration of contaminants 24 and solids stream with reduced concentration of contaminants 26. The temperature inside of extractor 12 may vary between ambient temperature and the boiling point of the solvent used. Depending on the configuration of the system and materials being processed, extractor 12 may remove at least 20 weight percent of the contaminants from the contaminated solid material 20, such as at least 50 weight percent, at least 75 weight percent, or at least 90 weight percent. For example, extractor 12 may remove from 30 weight percent to 95 weight percent of one or more contaminants, such as from 50 weight percent to 90 weight percent.

To prepare the solids stream with reduced concentration of contaminants 26 for downstream use, system 10 includes solids desolventizer 14. Solids desolventizer 14 can receive the solids stream with reduced concentration of contaminants 26 and heat the stream to remove residual solvent from the solids. For example, solids desolventizer 14 may be implemented using a desolventizer toaster or other desolventizing device that increases the temperature of the solids stream with reduced concentration of contaminants 26. The temperature of the stream may be increased to a temperature above the boiling point of the solvent used in extractor 12, causing residual solvent to vaporize. In some configurations, steam is injected into solids desolventizer 14 in addition to or in lieu of any other direct or indirect heating.

A solvent stream with increased concentration of contaminants 24 is discharged from extractor 12 in FIG. 1. To recover the solvent for recycle to extractor 12 and/or other reuse, system 10 may include a solvent recovery or distillation unit 16. The solvent recovery unit can receive the solvent stream with increased concentration of contaminants 24 and separate contaminants in the solvent from the solvent itself In different configurations, solvent recovery unit 16 may be a filtration unit, distillation unit, or other equipment that separates the solvent from the contaminants therein. Solvent recovery unit 16 can generate a recovered solvent stream 28 having a reduced concentration of contaminants as compared to incoming solvent stream 24. In some examples, solvent recovery unit 16 removes substantially all of the contaminants picked up into the solvent stream in extractor 12.

Solvent recovery unit 18 may partially or fully evaporate the solvent stream with increased concentration of contaminants 24. This can produce a contaminant stream 30 that is a sludge or residue containing the contaminants extracted inside of extractor 10. This sludge or residue may optionally be further processed in a contaminant separation unit 18. For example, contaminant stream 30 may be a solvent-containing stream rich in contaminants. Contaminant stream 30 may be a bottoms stream from a distillation tower used to recover solvent that is recycled to extractor 12. Contaminant separation unit 18 can separate contaminants extracted from contaminated solids 20 into solvent from the solvent itself. For example, in instances where an organic solvent is used in extractor 10, contaminant separation unit 18 can separate the contaminants in the contaminant stream 30 from residual solvent. The specific type of separation unit used as contaminant separation unit 18 may vary based on the types of materials being processed and the composition of the contaminants removed.

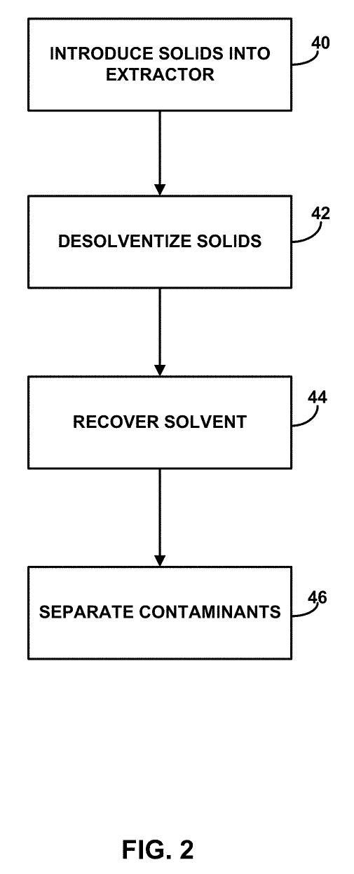

FIG. 2 is a block diagram illustrating an example solid-solvent extraction process. The process includes introducing a contaminant-containing solid material into an extractor, along with a solvent, and extracting the at least some of the contaminant from the solid material into the solvent (40). In one example, the solid material is a petroleum coke containing heavy metals. The petroleum coke is introduced into a continuous extractor (e.g., counter-current immersion extractor) along with an organic solvent. As the contaminated petroleum coke and solvent move through the extractor, heavy metal(s) may extract out of the petroleum coke and into the organic solvent.

The process of FIG. 2 also includes desolventizing solids material having undergone extraction and having been discharged from the extractor (42). For example, in the case of petroleum coke having undergone solvent extraction to remove heavy metal(s), the petroleum coke discharged from the solvent extractor may be wet with residual solvent. To prepare the petroleum coke with reduced concentration of heavy metals for shipping, storage, and/or use, the petroleum coke may be heated (optionally in the presence of steam) to a temperature above a boiling point of the solvent used in the extractor. The elevated temperature may drive the residual organic solvent off of the petroleum coke.

In FIG. 2, solvent discharged from the extractor with an increased concentration of contaminants is processed to recover the solvent (44). In the example of petroleum coke that is extracted with an organic solvent, the organic solvent having an increased concentration of contaminants (having been extracted out of the petroleum coke) may be sent to one or more distillation columns. The organic solvent may be partially vaporized within the distillation column(s), producing an organic solvent stream substantially devoid of contaminants and a bottoms organic solvent stream rich with concentrated contaminants. The organic solvent stream substantially devoid of contaminants may be recycled back to the solvent inlet of the extractor. The bottoms organic solvent stream rich with concentrated contaminants may or may not be further processed.

The process of FIG. 2 shows the bottoms organic solvent stream rich with concentrated contaminants being further processed to separate contaminants from residual solvent (44). In the case of petroleum coke, the organic solvent stream may be processed to remove residual solvent from the concentrated heavy metal contaminants. In removed solvent may or may not also be recycled back to the extractor. Further, the heavy metal contaminants may or may not be separated from one another, e.g., to provide specific heavy metals separated from one another for further processing or disposal.

As noted above, a technique according to the disclosure can be performed on a wide variety of different solid materials containing contaminants. One example of a solid material that may be desirably processed is petroleum coke that has been calcined. While the composition of such a coke may vary, e.g., based on the composition of the crude oil used to produce the coke, in some examples, the coke has greater than 90 weight percent carbon, such as greater than 95 weight percent carbon, or greater than 98 weight percent carbon. The coke may one or more metals that are contaminants, such as from 5 ppm by weight to 50 ppm chromium, from 10 ppm to 60 ppm cobalt, from 50 ppm to 5000 ppm iron, from 2 ppm to 100 ppm manganese, from 10 ppm to 20 ppm molybdenum, from 10 ppm to 500 ppm nickel, and/or from 5 ppm to 500 ppm vanadium. An extraction technique as described herein may reduce the concentration of one or more of these contaminants by those percentages discussed above.

Various examples have been described. These and other examples are within the scope of the following claims.

1. A method comprising:
introducing a solid material containing at least one contaminant into an extractor;
introducing a solvent into the extractor;
extracting at least some of the at least one contaminant contained in the solid material from the solid material into the solvent within the extractor, thereby producing a solvent with increased concentration of contaminant and a solid material with reduced concentration of contaminant;
discharging the solid material with reduced concentration of contaminant from the extractor and conveying the solid material with reduced concentration of contaminant to a desolventizer;
discharging the solvent with increased concentration of contaminant from the extractor and conveying the solvent with increased concentration of contaminant to a solvent recovery unit;
desolventizing the solid material with reduced concentration of contaminant inside of the desolventizer; and
separating at least some of the contaminants extracted into the solvent with increased concentration of contaminant from the solvent inside the solvent recovery unit.

2. The method of claim 1, further comprising recycling solvent recovered in the solvent recovery unit to the extractor.

3. The method of claim 1, wherein the solvent recovery unit generates a contaminant-rich stream, and further comprising the contaminant-rich stream in a contaminant separation unit.

4. The method of claim 1, wherein the solid material containing at least one contaminant comprises a petroleum byproduct.

5. The method of claim 4, wherein the petroleum byproduct comprises petroleum coke.

6. The method of claim 4, wherein the at least one contaminant comprises a heavy metal. The method of claim 1, wherein the solvent comprises an organic solvent.

8. The method of claim 1, wherein extracting at least some of the at least one contaminant contained in the solid material from the solid material into the solvent comprises conveying the solid material and the solvent in countercurrent directions through the extractor.

9. The method of claim 1, further comprising recycling solvent recovered in the desolventizer to the extractor.

10. A method of purifying petroleum coke comprising:
introducing a petroleum coke containing a contaminant selected from the group consisting of antimony, cobalt, manganese, molybdenum, nickel, selenium, silver, tin, vanadium, zinc, and combinations thereof into an extractor;
introducing an organic solvent into the extractor;
extracting at least 20 weight percent of the contaminant from the petroleum coke into the organic solvent within the extractor, thereby producing an organic solvent containing the contaminant and extracted petroleum coke;
discharging the extracted petroleum coke from the extractor and conveying the extracted petroleum coke to a desolventizer;
discharging the organic solvent containing the contaminant from the extractor and conveying the solvent containing the contaminant to a solvent recovery unit;
desolventizing the extracted petroleum coke inside of the desolventizer at a temperature above a boiling point of the organic solvent; and
separating at least some of the contaminant from the solvent containing the contaminant inside the solvent recovery unit.

11. The method of claim 10, further comprising recycling solvent recovered in the solvent recovery unit to the extractor.

12. The method of claim 10, wherein the solvent recovery unit generates a contaminant-rich stream, and further comprising the contaminant-rich stream in a contaminant separation unit.

13. The method of claim 10, further comprising, generating the petroleum coke in an oil refinery coker unit.

14. The method of claim 10, wherein extracting at least 20 weight percent of the contaminant from the petroleum coke into the organic solvent comprises conveying the petroleum coke and the organic solvent in countercurrent directions through the extractor.

15. The method of claim 10, further comprising recycling the organic solvent recovered in the desolventizer to the extractor.

16. The method of claim 10, wherein extracting at least 20 weight percent of the contaminant from the petroleum coke into the organic solvent comprises extracting from 50 weight percent to 90 weight percent of the contaminant from the petroleum coke into the organic solvent.
